(19) United States
(12) Patent Application Publication
(10) Pub. No.: US 2012/0242666 A1
(43) Pub. Date: Sep. 27, 2012

(54) APPARATUS AND METHOD FOR DISPLAYING IMAGE

(75) Inventor: Takafumi NANJO, Sagamihara-shi (JP)

(73) Assignee: KONICA MINOLTA MEDICAL & GRAPHIC, INC., Tokyo (JP)

(21) Appl. No.: 13/426,039

(22) Filed: Mar. 21, 2012

(30) Foreign Application Priority Data
Mar. 22, 2011 (JP) 2011-061887

(51) Int. Cl. G06T 17/00

(52) U.S. Cl. 345/428

(57) ABSTRACT

An image display apparatus includes: a display unit having a display area for displaying a medical image; a determination unit for determining whether or not to generate bitmap data of a thinned image generated by thinning pixels from the medical image, based on first numbers of pixels in first two orthogonal directions that constitute the medical image and second numbers of pixels in second two orthogonal directions that constitute the display area and correspond to the first two orthogonal directions, respectively; and a display controller for, when the determination unit determines to generate the bitmap data of the thinned image, generating the bitmap data of the thinned image, displaying the thinned image on the display unit, generating a bitmap data of an original image of the medical image without thinning pixels therefrom, and displaying the original image alternative to the thinned image being displayed on the display unit.

### BACKGROUND OF THE INVENTION

1. Field of the Invention

The present invention relates to an apparatus and a method for displaying an image.

2. Description of Related Art

In recent years, medical images photographed by a modality such as computed radiography (CR), computed tomography (CT), magnetic resonance (MR), and the like, have been stored in an image server in the form of digital images, as picture archiving and communication system (PACS) has come into wide use. The digital images stored in the image server have various resolutions depending on kinds of modalities. For example, the number of pixels of some mammogram image can be huge such as 7080×9480 (about 130 MB per image).

When displaying an image having a large size on a client terminal connected to an image server via a network, it takes much time to read such large images. In typical interpretations, images are at first displayed to fit a monitor size in order that a user can grasp a whole view of the image (frame size display).

Accordingly, an image display system has been proposed in which a low-resolution image is displayed first, and then a high-resolution image is displayed when it is possible to change the low-resolution image to an image having a higher-resolution (see Japanese Patent Application Laid Open Publication No. 2009-66306).

However, if a low-resolution image is always to be displayed prior to a high-resolution image for every image, it causes lack of diagnosis information when the number of pixels in an image to be displayed is smaller than effective pixels of a monitor.

In this way, displaying an image at a high resolution may cause decrease of an efficiency of image interpretation because of taking much time to display an image, though there exists a demand for keeping certain image quality.

### SUMMARY OF THE INVENTION

The present invention has been made in consideration for the foregoing problem in the related art, and an object of the present invention is to improve an efficiency of medical image interpretation.

In order to accomplish the above object, in accordance with a first aspect of the present invention, there is provided an image display apparatus, including: a display unit having a display area for displaying a medical image; a determination unit for determining whether or not to generate bitmap data of a thinned image generated by thinning pixels from the medical image, based on first numbers of pixels in first two orthogonal directions that constitute the medical image and second numbers of pixels in second two orthogonal directions that constitute the display area and correspond to the first two orthogonal directions, respectively; and a display controller for, when the determination unit determines to generate the bitmap data of the thinned image, generating the bitmap data of the thinned image, displaying the thinned image on the display unit, generating a bitmap data of an original image of the medical image without thinning pixels therefrom, and displaying the original image alternative to the thinned image being displayed on the display unit.

According to the first aspect of the present invention, when generating a thinned image, time required to display the first image is shortened, so that efficiency improvement of image interpretation will be achieved.

Preferably, the determination unit determines to generate the bitmap data of the thinned image when numbers of pixels in both the first two orthogonal directions in the thinned image are larger than the corresponding second numbers of pixels, respectively.

In accordance with the present invention, when the numbers of pixels in the thinned image are larger than the second numbers of pixels in the display area of the display unit in both the corresponding two orthogonal directions, the thinned image is thought to be adequate to be displayed first, thus efficiency improvement of image interpretation will be achieved.

In accordance with a second aspect of the present invention, there is provided a method for displaying a medical image on a display area of a display unit, including the steps of: determining whether or not to generate bitmap data of a thinned image generated by thinning pixels from the medical image, based on first numbers of pixels in first two orthogonal directions that constitute the medical image and second numbers of pixels in second two orthogonal directions that constitute the display area and correspond to the first two orthogonal directions, respectively; and when determined to generate the bitmap data of the thinned image in the determination step, generating the bitmap data of the thinned image, displaying the thinned image on the display unit, generating bitmap data of an original image of the medical image without thinning pixels therefrom, and displaying the original image alternative to the thinned image being displayed on the display unit.

In accordance with the second aspect of the present invention, when generating the bitmap data of the thinned image, time required to firstly display the image is shortened, so that efficiency improvement of image interpretation will be achieved.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a system configuration diagram of a medical image display system according to an embodiment of the present invention;

FIG. 2 is a block diagram showing a functional configuration of an image server according to an embodiment of the present invention;

FIG. 3 is a block diagram showing a functional configuration of a client terminal according to an embodiment of the present invention;

FIG. 4 is a flowchart showing a process of displaying a medical image executed by the client terminal;

FIG. 5 is a flowchart showing a process of displaying a medical image executed by the client terminal;

FIG. 6 is an example showing a case of a dual monitor display where two medical images are displayed on each monitor;

FIGS. 7A to 7C are views for explaining examples of determination to display a medical image at a frame size; and

FIGS. 8A to 8C are views for explaining examples of determination to display a medical image at a two-fold frame size.

### DETAILED DESCRIPTION OF PREFERRED EMBODIMENT

An embodiment of the present invention will be described with reference to the drawings.

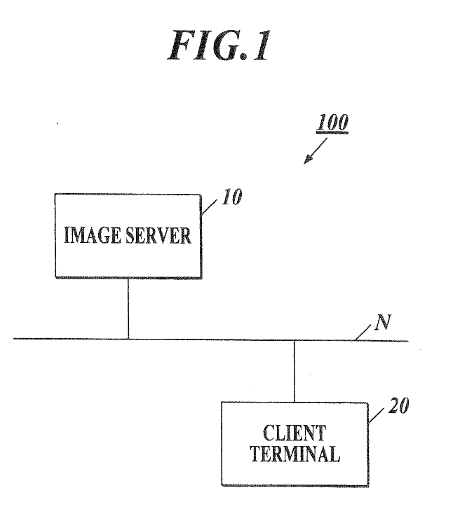

FIG. 1 shows a system configuration of a medical image display system 100. As shown in FIG. 1, the medical image display system 100 includes an image server 10 and a client terminal 20 that functions as an image display apparatus. The image server 10 and the client terminal 20 are connected to each other through a network N such as a local area network (LAN) to transmit and receive data therebetween. The network N is compliant with the digital imaging and communications in medicine (DICOM) standard.

The image server 10, adopting PACS, stores a file of image data of a medical image generated by a modality (hereinafter referred to as “image files”) and provides the image files or the like in response to requests from an external device such as the client terminal 20.

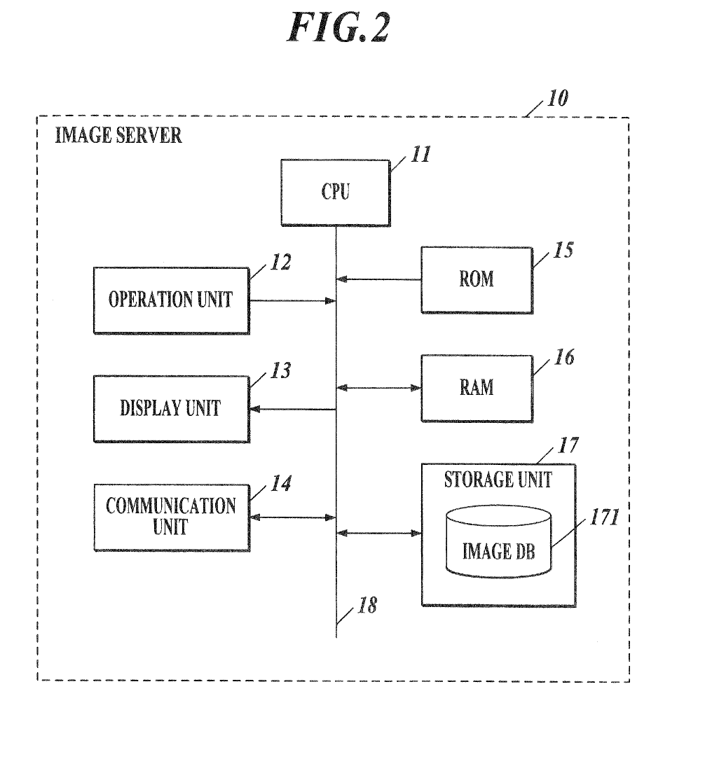

FIG. 2 shows a functional configuration of the image server 10. As shown in FIG. 2, the image server 10 includes a central processing unit (CPU) 11, an operation unit 12, a display unit 13, a communication unit 14, a read only memory (ROM) 15, a random access memory (RAM) 16, and a storage unit 17, which are connected to each other by a bus 18.

The CPU 11 controls operations of each component of the image server 10 in a centralized manner. Specifically, the CPU 11 reads out various processing programs stored in the ROM 15 in response to an operation signal input from the operation unit 12 or an instruction signal received by the communication unit 14, expands the processing programs into a work area created in the RAM 16, and then executes a variety of processes in cooperation with the processing programs.

The operation unit 12 includes a keyboard having cursor keys, numeric keys, other function keys, and the like, and a pointing device such as a mouse, and outputs an operation signal, which is input through key operation on the keyboard or mouse operation, to the CPU 11.

The display unit 13 includes a liquid crystal display (LCD), and displays images on the display based on display data input by the CPU 11.

The communication unit 14 corresponds to an interface which transmits and receives data to and from an external device such as the client terminal 20.

The ROM 15 is composed of a non-volatile semiconductor memory, or the like, and stores control programs and parameters or files that are necessary for executing the control programs.

The RAM 16 creates a work area for temporarily storing programs, input data or output data, parameters that are read out from the ROM 15, and the like, at various processes the execution of which is controlled by the CPU 11.

The storage unit 17 is composed of a hard disk or the like and stores various data. Concretely, the storage unit 17 stores an image database (image DB) 171. The image DB 171 stores a plurality of the image files and relevant image information thereof respectively corresponding to the image files. For example, an image file of phase contrast mammography (PCM) image obtained through X-ray photography to the breasts by using the phase contrast X-ray mammography or the like is adopted as the image file.

The image information includes a file path of the image file, the numbers of pixels in the lateral direction (X direction) and vertical direction (Y direction) of a medical image, various LUT information (modality LUT, and VOI LUT), and parameters used for generating an image (such as storage bits, allocation bits, high-order bits, photometric interpretation, planar configuration, and pixel representation).

The CPU 11 reads out a requested image file or image information from the image DB 171 of the storage unit 17 when the CPU 11 receives an acquisition request of the image file or the image information from the client terminal 20, and transmits the image file or the image information to the client terminal 20.

The client terminal 20 is an apparatus for displaying the medical image based on the image file obtained from the image server 20 to execute an interpretation of the medical image, and is composed of a personal computer (PC) or the like.

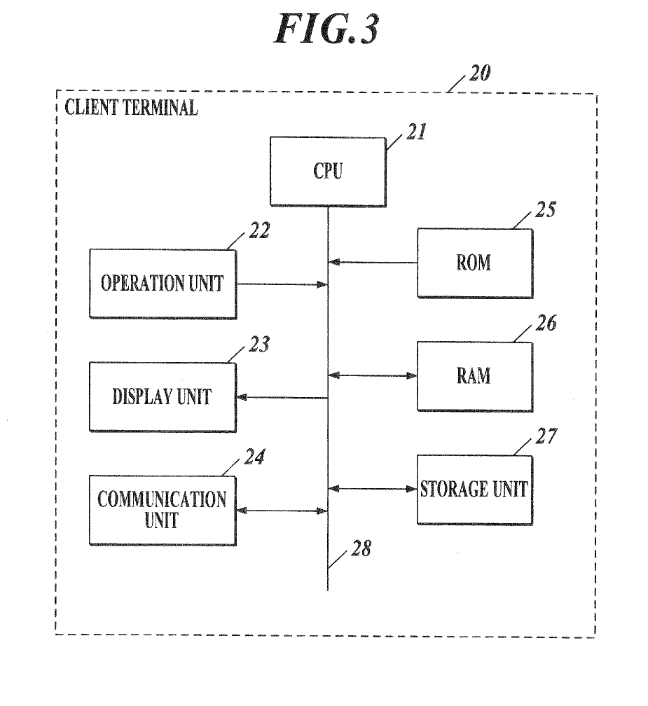

FIG. 3 shows a functional configuration of the client terminal 20. As shown in FIG. 3, the client terminal 20 includes a CPU 21, an operation unit 22, a display unit 23, a communication unit 24, a ROM 25, a RAM 26, and a storage unit 27, which are connected to each other by a bus 28.

The CPU 21 controls operations of each component of the client terminal 20 in a centralized manner. Specifically, the CPU 21 reads out a variety of processing programs stored in the ROM 25 in response to an operation signal input from the operation unit 22 or an instruction signal received by the communication unit 24, expands the processing programs into a work area created in the RAM 26, and then executes a variety of processes in cooperation with the processing programs.

The operation unit 22 is a functional unit which receives operation instructions from users. The operation unit 22 includes a keyboard including such as cursor keys, numeric keys, a variety of function keys, and a pointing device such as a mouse, and outputs operation signals that are input through operating a keyboard or a mouse, to the CPU 11.

The display unit 23 is a high-resolution monitor composed of an LCD, and displays images on the display based on a display data (bitmap data) input by the CPU 21. For example, the display unit 23 displays a medical image to be interpreted.

The communication unit 24 corresponds to an interface which transmits and receives data to and from an external device such as the image server 10.

The ROM 25 is composed of a non-volatile semiconductor memory, or the like, and stores control programs and parameters or files that are necessary to execute the control programs.

The RAM 26 creates a work area for temporarily storing a variety of programs, input data or output data, parameters read out from the ROM 25, and the like, at various processes the execution of which is controlled by the CPU 21. Specifically, the RAM 26 stores image files or the like obtained from the image server 10.

The storage unit 27 is composed of a hard disk and stores various data. The storage unit 27 stores a display setting information used when displaying an image on the display unit 23. The display setting information includes the number of partitions of the display (number of images displayed on the display), the top left corner coordinate of an area for displaying a medical image, sizes of each display area (the number of pixels in the lateral direction (X direction) and the vertical direction (Y direction) of the display area), and the magnification of the display (for example, “a frame size” or “double frame size”), and the like. The display setting information can be modified by user's operation input from the operation unit 12. “A frame size” refers to a size for displaying a medical image in full size of the display area of the display unit 23. “Double frame size” refers to a size for displaying a medical image being enlarged in a size of two fold of the size of the display unit 23 in each of the X direction and the Y direction.

The CPU 21 transmits an acquisition request of the image file or the image information of the medical image stored in the storage unit 17 to the image server 10 through the communication unit 24, and acquires the requested image file or the image information from the image server 10.

The CPU 21 determines whether or not to generate the bitmap data of a thinned image generated by thinning pixels from the medical image at a predetermined rate, based on the numbers of pixels (first numbers of pixels) in two orthogonal directions (X direction and Y direction: first two orthogonal directions) constituting the medical image, respectively, and the numbers of pixels (second numbers of pixels) in two orthogonal directions (X direction and Y direction: second two orthogonal directions) constituting the display unit 23 and corresponding to the first two orthogonal directions. That is, the CPU 21 functions as a determination unit. The information of the respective numbers of pixels in the X direction and the Y direction of the medical image is included in the image information obtained from the image server 10. The information of the respective numbers of pixels in the X direction and the Y direction of the display area of the display unit 23 is included in the display setting information stored in the storage unit 27. The embodiment is exemplified by a case of a thinning rate of ½ (thinning half of the pixels).

Specifically, the CPU 21 determines to generate the bitmap data of the thinned image when the number of pixels in a thinned area of the medical image to be displayed is larger than the number of pixels in the display area of the display unit 23 in each of the X direction and the Y direction. The numbers of pixels in the X direction and the Y direction of the thinned area of the medical image to be displayed are calculated based on the information of the number of pixels in the X direction and the Y direction of the medical image included in the image information and the information of the magnification of the display included in the display setting information.

For example, when a display magnification is ×1 (“×1”, or “100%” means displaying an image at a frame size), the numbers of pixels in the X direction and the Y direction constituting the area of the medical image to be displayed are equal to the numbers of pixels in the X and Y directions constituting the medical image. When a display magnification is ×2 (200%), the numbers of pixels in the X direction and the Y direction constituting the area of a medical image to be displayed are half of the numbers of pixels in the X and the Y direction constituting the medical image.

The CPU 21, when determining to generate the bitmap data of the thinned image, generates the bitmap data of the thinned image created by thinning the medical image, and then instructs the display unit 23 to display the thinned image. Thereafter, the CPU 21 generates an original bitmap data without thinning pixels from the medical image, and changes the image being displayed on the display unit 23 from the thinned image to the original image. That is, the CPU 21 works as a display controller.

Next, an operation of the system is described.

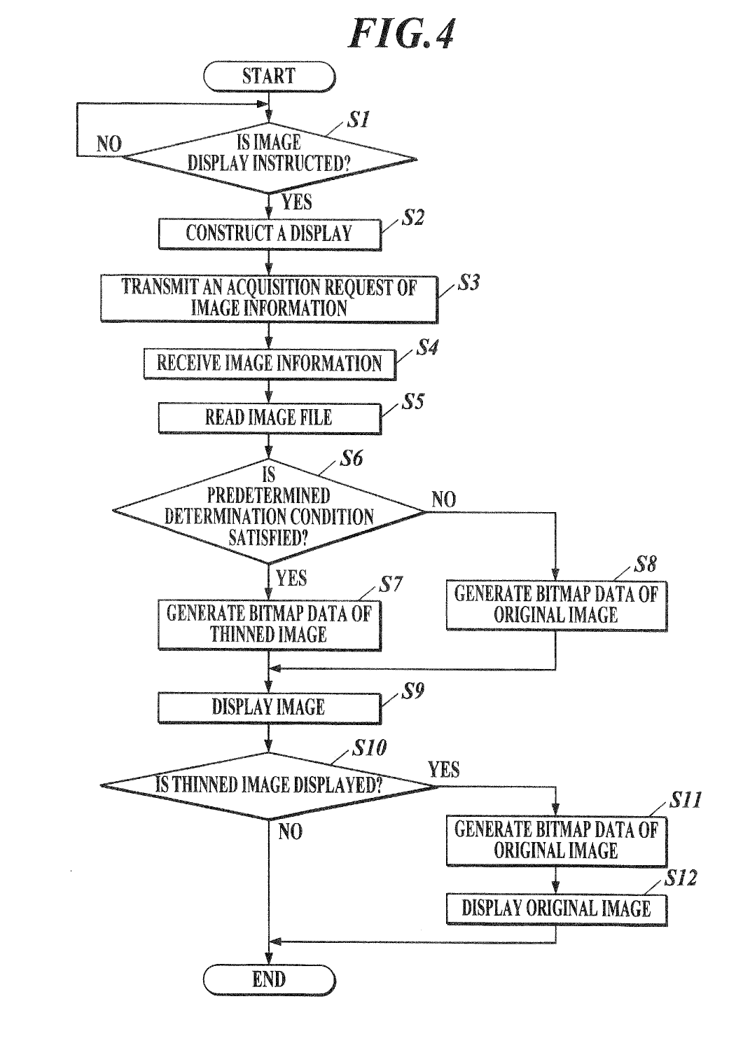

FIG. 4 is a flowchart showing a process of displaying medical images executed in the client terminal 20. This process is implemented by software processing executed by the CPU 21 in cooperation with programs stored in the ROM 25.

First, a user inputs an instruction to display an image through the operational unit 22 (step S1; YES), and the CPU 21 then constructs a display (Step S2). Specifically, the CPU 21 reads out the display setting information stored in the storage unit 27, and determines the number of partitions of the display, the top left corner coordinate of an area of the display for displaying the medical image, a size of each display area, and a display magnification.

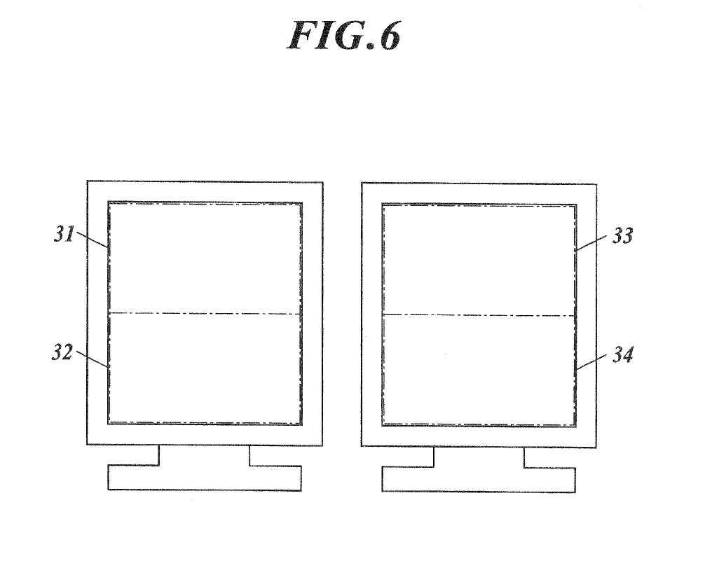

For example, FIG. 6 shows an example when the display unit 23 is a dual monitor display. In a dual monitor display, two medical images are displayed on each two monitors in a frame size. That is, four medical images are displayed in total. The regions 31-34 are the areas on which medical images are displayed.

Next, the CPU 21 transmits an acquisition request of the image information to the image server 10 through the communication unit 24 (Step S3).

In the image server 10, the CPU 11 receives the acquisition request of the image information through the communication unit 14, and then reads out the image information from the image DB 171 in accordance with the request, and transmits the requested image information which is read out from the image DB 171 to the client terminal 20 through the communication unit 14.

In the client terminal 20, the CPU 21 obtains the image information from the image server 10 through the communication unit 24 (Step S4). The CPU 21 stores the received image information in the RAM 26.

Next, the CPU 21 reads an image file from the image server 10 through the communication unit 24 based on a file path of the image file included in the obtained image information, and then loads the image file into the RAM 26 (Step S5). Specifically, the CPU 21 transmits an acquisition request of the image file of the medical image to the image server 10, and receives the image file from the image server 10.

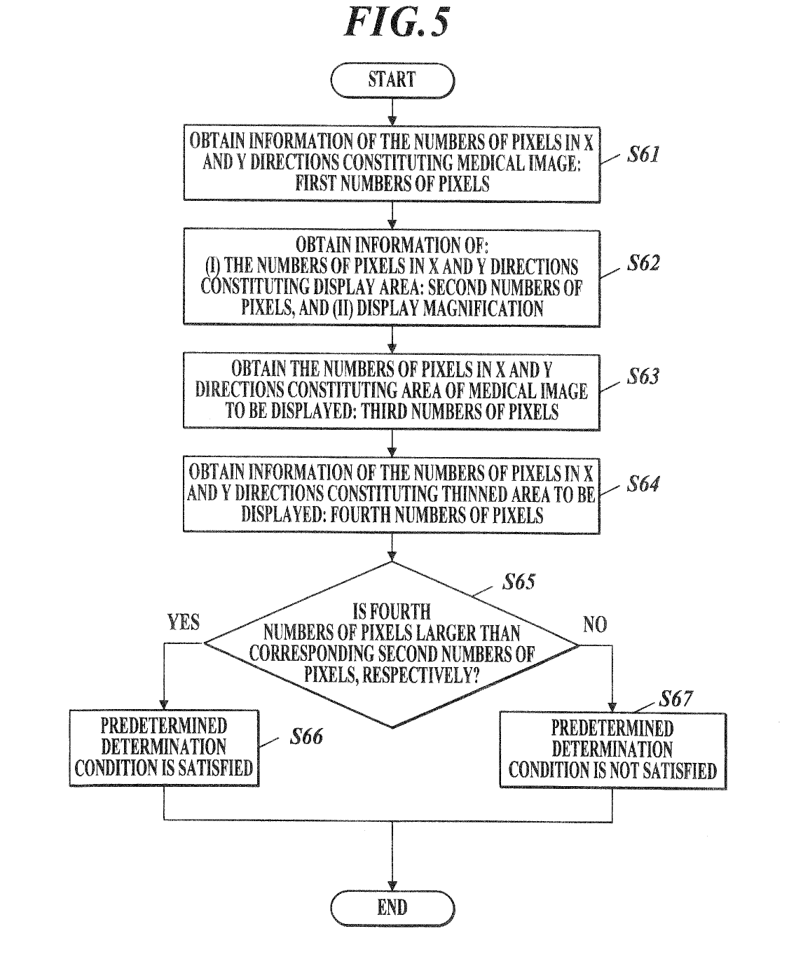

The CPU 21 determines whether or not the medical image satisfies a predetermined determination condition based both on the image information from the image DB 171 and the image display setting information stored in the storage unit 27. In this embodiment of the present invention, as shown in FIG. 5, the CPU 21 determines whether or not to generate the bitmap data of the thinned image of the medical image based on the numbers of pixels in the X direction and the Y direction constituting the medical image (first numbers of pixels), respectively, and the numbers of pixels in the X direction and the Y direction constituting the display area of the display unit 23 (second numbers of pixels).

Specifically, the CPU 21 obtains the information of the numbers of pixels in the X direction and the Y direction constituting the medical image included in the image information received at the Step S4 (Step S61), information of the numbers of pixels in the X direction and the Y direction constituting the display area of the display unit 23 (second numbers of pixels), and the information of the display magnification stored in the storage unit 27 (Step S62). Then the CPU 21 calculates the numbers of pixels in the X direction and the Y direction constituting the area of the medical image to be displayed based on the numbers of pixels in the X direction and the Y direction constituting the medical image and the display magnification (Step S63). Thereafter the CPU 21 determines to generate the bitmap data of the thinned image when the numbers of pixels in the X direction and the Y direction constituting the thinned area of the medical image to be displayed (fourth numbers of pixels) (Step S64) is larger than the numbers of pixels in the X direction and the Y direction constituting the display area of the display unit 23 (second numbers of pixels) (Step S65; YES, S66, S6; YES).

When the predetermined determination condition is satisfied (Step S6; YES), that is, the numbers of pixels constituting the thinned area of the medical image to be displayed is larger than the numbers of pixels constituting the display area of the display unit 23 in both of the X direction and the Y direction, the CPU 21 generates the bitmap data of the thinned area of the medical image to be displayed based on the image file of the medical image (Step S7). A format of thinning can be the JPEG 2000 format.

When the predetermined determination condition is not satisfied (Step S6; NO), that is, the numbers of pixels constituting the thinned area of the medical image to be displayed is not more than the numbers of pixels constituting the display area of the display unit 23 in either of the X direction or the Y direction, the CPU 21 generates the bitmap data of the original image based on the image file of the medical image without thinning pixels therefrom (Step S8).

After Step S7 or S8, the CPU 21 displays the thinned image or the original image on the display area of the display unit 23 based on the bitmap data of thinned image or the bitmap data of the original image (Step S9).

Next, the CPU 21 judges whether or not the thinned image is being displayed on the display unit 23 (Step S10). When the thinned image is being displayed (Step S10; YES), the CPU 21 generates the bitmap data of the original image by threading based on the image file of the medical image without thinning pixels therefrom (Step S11). Then the CPU 21 displays the original image on the display unit 23 based on the bitmap data of the original image (Step S12). That is, the CPU 21 changes the image being displayed on the display unit 23 from the thinned image to the original image.

When the thinned image is not being displayed on the display unit 23 (Step S10; NO), whole process is finished.

This is the end of the process of displaying medical images.

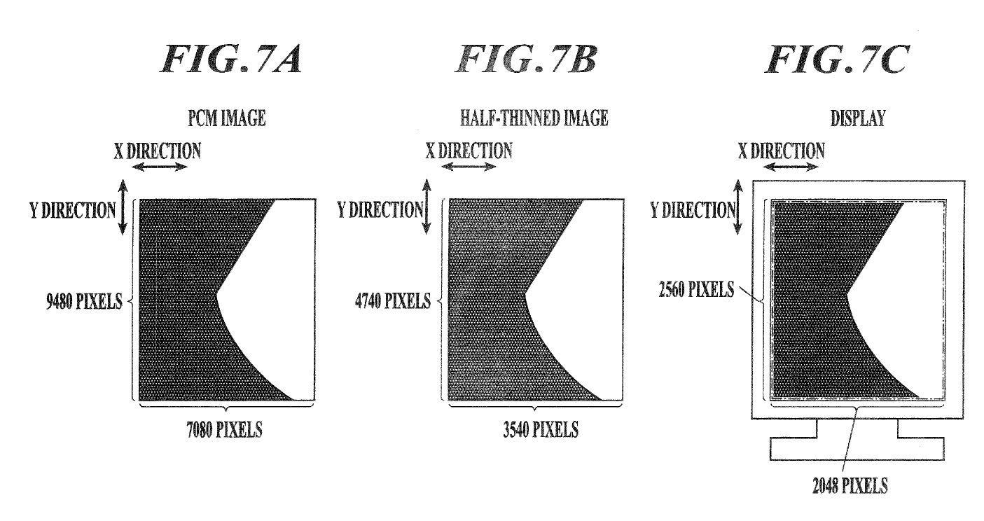

FIGS. 7A, 7B and 7C show medical images that are displayed at a frame size when the number of partitions of a display is 1×1

FIG. 7A shows an example of a PCM image including 7080 pixels (X direction)×9480 pixels (Y direction). When displayed in a frame size, the display area of the medical image corresponds to the size of the medical image (7080 pixels×9480 pixels).

FIG. 7B shows an example when the PCM image of FIG. 7A is formed by thinning a half of pixels in each of the X direction and the Y direction. As a result of the thinning, the area of the PCM image to be displayed includes 3540 pixels (X direction)×4740 pixels (Y direction).

As shown in FIG. 7C, the size of the display area of the display unit 23 is assumed to include 2048 pixels in the X direction and 2560 pixels in the Y direction.

Comparing the number of pixels in the X direction of the half-thinned PCM image (3540 pixels) and the number of pixels in the X direction of the display area of the display unit 23 (2048 pixels), the number of pixels in the X direction of the half-thinned PCM image is larger.

Comparing the number of pixels in the Y direction of the half-thinned PCM image (4740 pixels) and the number of pixels in the Y direction of the display area of the display unit 23 (2560 pixels), the number of pixels in the Y direction of the half-thinned PCM image is larger.

Accordingly, in the case shown in FIGS. 7A, 7B and 7C, the number of pixels in the thinned image is larger than the number of pixels in the display area of the display unit 23 in each of the X direction and the Y direction, thus the half-thinned PCM image is displayed first, and then changed to the original image.

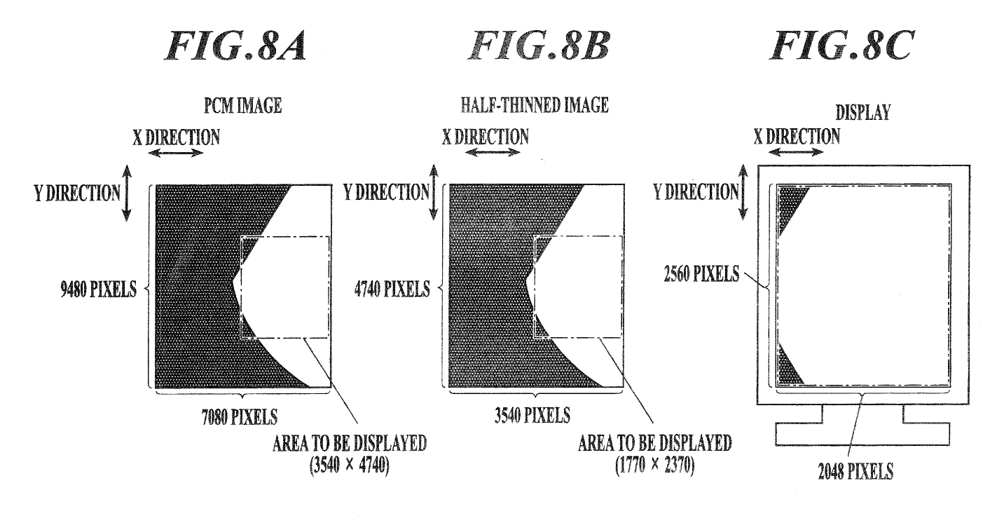

FIGS. 8A, 8B and 8C show examples of medical images that are displayed at double frame size when the number of partitions of a display is 1×1.

FIG. 8A shows an example that a PCM image includes 7080 pixels (X direction)×9480 pixels (Y direction). When displayed at double frame size, an area of the medical image to be displayed is 3540 pixels (X direction)×4740 pixels (Y direction).

FIG. 8B shows an example that the PCM image is formed by thinning a half of pixels in each of the X direction and the Y direction (3540 pixels×4740 pixels). As a result of the thinning, the area of the PCM image to be displayed includes 1770 pixels (X direction) and 2370 pixels (Y direction).

As shown in FIG. 8C, the size of the display area of the display unit 23 is assumed to include 2048 pixels (X direction)×2560 pixels (Y direction).

Comparing the number of pixels in the X direction of the half-thinned PCM image (1770 pixels) and the number of pixels in the display area of the display unit 23 (2048 pixels), the number of pixels in the X direction of the display area of the display unit 23 is larger.

Comparing the number of pixels in the Y direction of the half-thinned PCM image (2370 pixels) and the number of pixels in the Y direction of the display area of the display unit 23 (2560 pixels), the number of pixels in the Y direction of the display area of the display unit 23 is larger.

Accordingly, in the case shown in FIGS. 8A, 8B and 8C, the number of pixels in the thinned image is smaller than or equal to the number of pixels in the display area of the display unit 23 in each of the X direction and the Y direction, thus only the original image is displayed first without generating the half-thinned image.

As described above, in the client terminal 20 of the medical image display system 100 of the embodiment of the invention, when generating the bitmap data of the thinned image, the time required to display the first image is shortened so that efficiency improvement of image interpretation will be achieved.

When the number of pixels in the area of the medical image to be displayed is larger than the number of pixels in the display area of the display unit 23, displaying the thinned image firstly on the display is adequate and efficiency improvement of image interpretation will be achieved.

When the number of pixels of the thinned area of the medical image to be displayed is not more than the number of pixels in the display area of the display unit 23, displaying the thinned image causes degradation of image quality. Thus the original image is displayed first in order to keep a certain image quality.

Note that the descriptions above are merely the examples of the image display apparatus of the invention thus are not intended as a definition of the limits of the present invention. It is also possible to appropriately modify detailed configurations and operations of the respective units configuring the apparatus within the scope without departing from the spirit of the invention.

For example, while the embodiment has been described with a case of a thinning rate of ½, this is not limitative.

In the foregoing descriptions, the ROM is described as an example of a recording medium that is readable by computer storing programs for executing processes, though this is not limitative. For example, a removable media such as a non-volatile semiconductor memory like a flash memory or a CD-ROM can be applied. Moreover, as a media for providing data of programs through a communication line, career waves can be applied.

According to one aspect of preferred embodiment of the present invention, there is provided a client terminal 20 including: the display unit 13 having a display area for displaying a medical image; the CPU 21 for determining whether or not to generate bitmap data of a thinned image generated by thinning pixels from the medical image, based on first numbers of pixels in first two orthogonal directions that constitute the medical image and second numbers of pixels in second two orthogonal directions that constitute the display area and correspond to the first two orthogonal directions, respectively; and the CPU 21 for, when the determination unit determines to generate the bitmap data of the thinned image, generating the bitmap data of the thinned image, displaying the thinned image on the display unit 13, generating a bitmap data of an original image of the medical image without thinning pixels therefrom, and displaying the original image alternative to the thinned image being displayed on the display unit 13.

In the client terminal 20, when a thinned image is generated first, the time required to display a thinned image first is shorter than the time to display an original image first so that efficiency improvement of image interpretation will be achieved.

Preferably, in the client terminal 20, the CPU 21 determines to generate the bitmap data of the thinned image when numbers of pixels in both the first two orthogonal directions in the thinned image are larger than the corresponding second numbers of pixels, respectively.

In the client terminal 20, when the numbers of pixels in the thinned image are larger than the second numbers of pixels in the display area of the display unit in both the corresponding two orthogonal directions, the thinned image is thought to be adequate to be displayed first, thus efficiency improvement of image interpretation will be achieved.

In accordance with another aspect of preferred embodiment of the invention, there is provided a method for displaying a medical image on a display area of the display unit 13, including the steps of: determining whether or not to generate bitmap data of a thinned image generated by thinning pixels from the medical image, based on first numbers of pixels in first two orthogonal directions that constitute the medical image and second numbers of pixels in second two orthogonal directions that constitute the display area and correspond to the first two orthogonal directions, respectively; and when determined to generate the bitmap data of the thinned image in the determination step, generating the bitmap data of the thinned image, displaying the thinned image on the display unit 13, generating bitmap data of an original image of the medical image without thinning pixels therefrom, and displaying the original image alternative to the thinned image being displayed on the display unit 13.

In accordance with the second aspect of the present invention, when generating the bitmap data of the thinned image, time required to firstly display the image is shortened, so that efficiency improvement of image interpretation will be achieved.

The entire disclosure of Japanese Patent Application No. 2011-061887 filed on Mar. 22, 2011 is incorporated herein by reference in its entirety.

What is claimed is:

1. An image display apparatus, comprising:
a display unit having a display area for displaying a medical image;
a determination unit for determining whether or not to generate bitmap data of a thinned image generated by thinning pixels from the medical image, based on first numbers of pixels in first two orthogonal directions that constitute the medical image and second numbers of pixels in second two orthogonal directions that constitute the display area and correspond to the first two orthogonal directions, respectively; and
a display controller for, when the determination unit determines to generate the bitmap data of the thinned image,
generating the bitmap data of the thinned image,
displaying the thinned image on the display unit,
generating a bitmap data of an original image of the medical image without thinning pixels therefrom, and
displaying the original image alternative to the thinned image being displayed on the display unit.

2. The image display apparatus according to claim 1,
wherein the determination unit determines to generate the bitmap data of the thinned image when numbers of pixels in both the first two orthogonal directions in the thinned image are larger than the corresponding second numbers of pixels, respectively.

3. A method for displaying a medical image on a display area of a display unit, comprising the steps of:
determining whether or not to generate bitmap data of a thinned image generated by thinning pixels from the medical image, based on first numbers of pixels in first two orthogonal directions that constitute the medical image and second numbers of pixels in second two orthogonal directions that constitute the display area and correspond to the first two orthogonal directions, respectively; and
when determined to generate the bitmap data of the thinned image in the determination step,
generating the bitmap data of the thinned image,
displaying the thinned image on the display unit,
generating bitmap data of an original image of the medical image without thinning pixels therefrom, and
displaying the original image alternative to the thinned image being displayed on the display unit.
